(19) United States
(12) Patent Application Publication
(10) Pub. No.: US 2007/0052704 A1
(43) Pub. Date: Mar. 8, 2007

(54) 3D graphics image formation

(75) Inventors: Christopher Pedley, Cambridge (GB); Johnathan Sean Callan, Cambridge (GB); Peter James Horsman, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/220,909

(22) Filed: Sep. 8, 2005

(51) Int. Cl. G06T 15/40

(52) U.S. Cl. 345/422

(57) ABSTRACT

A data processing apparatus operable to form a graphics image is disclosed. The apparatus comprises a data store for storing an object list of objects to be displayed within said graphics image; a colour buffer operable to store a plurality of pixels to be displayed as said graphics image; a depth buffer operable to store a depth value corresponding to a distance of a pixel within said colour buffer from a front or viewing plane of said graphics image; a plurality of data processors operable to process data in parallel, each of said plurality of data processors being operable to: derive a pixel value of an object from said object list; access a depth buffer value stored in said depth buffer at a position corresponding to said pixel and to replace it with a lock value and in response to said accessed depth buffer value not being said lock value, to: compare a depth of said pixel value with said accessed depth buffer value; and either in response to said comparison indicating said pixel value being closer to a viewing plane of said graphics image than said accessed depth buffer value said data processor is operable to write said pixel value to a corresponding position in said colour buffer and subsequently replace said lock value in said corresponding position in said depth buffer with a depth of said pixel value; or in response to said comparison indicating said object being further from said viewing plane of said graphics image than said accessed depth buffer value said data processor is operable to replace said lock value in said corresponding position in said depth buffer with said accessed depth buffer value.

### BACKGROUND OF THE INVENTION

1. Field of the Invention

This invention relates to the field of data processing systems. More particularly, this invention relates to the field of 3D graphics image processing.

2. Description of the Prior Art

In the field of 3D graphics a depth buffer is used to determine whether an object should be displayed or whether it should be obscured by an object in front of it and thus, should not be displayed. This assessment is done late in the graphics processing, and involves the use of two buffers, a colour buffer which stores the pixels to be displayed and a depth or Z buffer which stores the depth within the scene of the corresponding pixel in the colour buffer.

Information regarding drawable objects (often triangles) to be displayed is stored in an object list. Pixel values for each object can be derived from the object list, and these pixel values have a colour component relating to the colour of the object at that point and a depth value relating to the distance of the object at that point from the front or viewing plane of the image. Pixels of each object to be displayed are accessed and the depth of the accessed pixel is compared with a depth value stored in a corresponding position in the depth buffer. If the depth value of the object pixel is such that it would place the object pixel closer to a display screen than the value stored in the depth buffer would then the colour buffer is updated with the colour component from the object pixel and the depth buffer is updated with the depth value component from the object pixel. That is the pixel of the object is closer to the screen than the previously stored corresponding pixel and as such it should be displayed in preference to it.

This comparison and updating of the buffers is one of the most time consuming activities performed during graphics processing when implemented in software. It would therefore be desirable to be able to perform depth buffer processing in parallel, so that each of the objects can be processed in parallel in a multiprocessor system. This would clearly speed up the process considerably. However, potential problems could arise in such systems, as the processing requires the accessing and updating of two buffers. If a parallel system was updating the same pixel at more or less the same time a situation could occur where two processes are racing for two buffers, and thus, one may update one and the other the other. This would lead to the depth value in the depth buffer not corresponding to the pixel in the colour buffer and could produce errors in the final image displayed.

In order to address this problem the depth buffer can be accessed under a lock. This prevents the depth buffer being accessed when another process is accessing it. This avoids the depth buffer being updated with an erroneous value but as it in effect does not allow processors to access it in parallel it effectively loses the advantages of parallel processing.

### SUMMARY OF THE INVENTION

Viewed from one aspect the present invention provides a method of forming a 3D graphics image comprising the steps of: (i) accessing a pixel value comprising a colour component and a depth component of an object derived from an object list: (ii) accessing a depth buffer value stored in a depth buffer at a position corresponding to said pixel and replacing said accessed depth buffer value with a lock value and if said accessed depth buffer value is not said lock value performing the following steps; (iii) comparing said depth component of said pixel value with said accessed depth buffer value; and (iva) in response to said comparison indicating said pixel value being closer to a viewing plane of said graphics image than said accessed depth buffer value writing said pixel value to a corresponding position in a colour buffer for storing pixels to be displayed and subsequently replacing said lock value in said corresponding position in said depth buffer with said pixel depth value; and (ivb) in response to said comparison indicating said object being further from said viewing plane of said graphics image than said accessed depth buffer value replacing said lock value in said corresponding position in said depth buffer with said derived depth buffer value.

The present invention recognises the above problem and addresses it by providing a lock value for each position or location that corresponds to a pixel within the depth buffer. This lock value is written to a depth buffer location that has been accessed and it prevents the data stored in this location from being overwritten by any other process. Thus, other locations within the depth buffer can be accessed and overwritten by other processes. At the end of the processing either the original value or the new value (if it is closer to the screen) is written to the depth buffer, this overwrites the lock value and that position of the depth buffer is thereby unlocked. This procedure has several advantages. One obvious advantage is that it is only individual positions in the depth buffer that are locked by the process at any one time. This makes the system suitable for parallel processing. Furthermore, during graphics processing many accesses and comparisons of the depth buffer result in it being updated. Thus, in these cases the unlocking of the position in the depth buffer can be performed without any overhead, simply by updating the lock with the new depth value which needs to be stored in any case.

In some embodiments said step (ii) further comprises comparing said accessed depth buffer value with said lock value to determine if said accessed depth buffer value is said lock value or not.

A convenient way of checking for a lock value is by a simple compare operation in which the accessed value is compared with the known lock value. A match indicating the position is locked.

In some embodiments in response to said depth buffer value accessed in said step (ii) being said lock value repeating said step (ii) until said accessed depth buffer value comprises a value other than said lock value.

If a different process is currently accessing the depth buffer position that you have just accessed then a lock value will be obtained. This lock value indicates that pixels at this position should not be processed at present and thus, the method repeats the step of accessing that position in the depth buffer until a value other than a lock value is obtained.

Although in some embodiments, said lock value is written to said depth buffer on accessing the depth buffer value and before it is compared with the lock value, in other embodiments in step (ii) said comparing of said accessed depth buffer value with said lock value is done prior to replacing said accessed depth buffer value with said lock value, and if said corresponding depth value is said lock value, said depth buffer is accessed again until said accessed depth buffer value is not said lock value.

In some embodiments said step (ii) is an atomic operation that cannot be interrupted.

The accessing of the position in the depth buffer and the locking of that position by the storage of a lock value should be an uninterruptable process to ensure safe operation. Once the buffer has been accessed, it should be locked to avoid any other process accessing the buffer at an almost identical moment and obtaining the depth buffer data before the first process has finished analysing it. The use of an atomic operation to access the depth buffer and lock it avoids this potential hazard.

In some embodiments said step (ii) comprises a swap operation operable to swap a lock value with said depth buffer value.

A swap operation is an atomic operation in that it locks the bus that it is using and prevents other processes from accessing the data until has completed. Thus, it is a convenient operation to use for step (ii) of the method.

In alternative embodiments, said step (ii) comprises an exclusive load and store operation.

An alternative to a swap is an exclusive load and store operation, this like the swap is an atomic operation and therefore has similar advantages to the swap in this context.

Preferably, said steps of said method are operable to be performed by a plurality of processors in parallel with each other.

As stated above, the method of the present invention is particularly appropriate for parallel processing as it effectively locks just the data that is being processed allowing the rest of the data in the buffer to be accessed. Furthermore, as it is rare for the same pixel position of two different objects to be analysed by two different processes at the same time this way of locking the buffer has very little impact on any parallel processing.

A further aspect of the present invention provides a computer program product, which is operable when run on a data processor to control the data processor to perform the steps of a method according to a first aspect of the present invention.

A still further aspect of the present invention provides a computer program product which is operable when run on a multiprocessor system to control a plurality of processors to each perform the steps of a method according to a first aspect of the present invention in parallel with each other.

A yet further aspect of the present invention provides a data processing apparatus operable to form a graphics image comprising: a data store for storing an object list of objects to be displayed within said graphics image; a colour buffer operable to store a plurality of pixels to be displayed as said graphics image; a depth buffer operable to store a depth value corresponding to a distance of a pixel within said colour buffer from a front of said graphics image; a plurality of data processors operable to process data in parallel, each of said plurality of data processors being operable to: derive a pixel value of an object from said object list; access a depth buffer value stored in said depth buffer at a position corresponding to said pixel and to replace it with said lock value and in response to said accessed depth buffer value not being a lock value, to: compare a depth of said pixel value with said accessed depth buffer value; and in response to said comparison indicating said pixel value being closer to a viewing plane of said graphics image than said accessed depth buffer value said data processor is operable to write said pixel value to a corresponding position in said colour buffer and subsequently replace said lock value in said corresponding position in said depth buffer with a depth of said pixel value; and in response to said comparison indicating said object being further from said viewing plane of said graphics image than said accessed depth buffer value said data processor is operable to replace said lock value in said corresponding position in said depth buffer with said accessed depth buffer value.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates multiple threads performing graphics processing according to an embodiment of the present invention;

FIG. 2 schematically shows a data processing apparatus according to an embodiment of the present invention; and

FIG. 3 shows a flow diagram giving a method for processing a graphics image according to an embodiment of the present invention.

### DESCRIPTION OF THE PREFERRED EMBODIMENTS

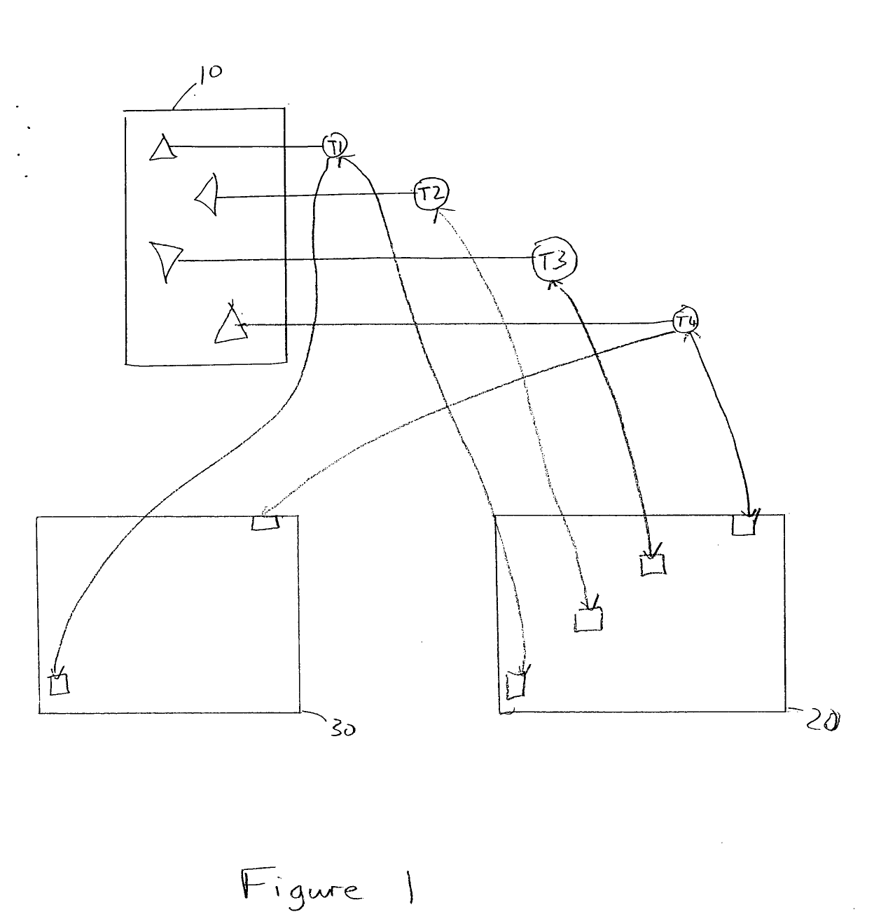

FIG. 1 schematically shows the functioning of an embodiment of the present invention in which multiple threads T1 to T4 of an application access different objects from an object list 10 and process the data independently of and in parallel with each other. In this embodiment each thread calculates a pixel of an object which relates to a particular position of that object on a display screen and comprises a colour component indicating the colour of that pixel and a depth component which indicates the depth of the object within the graphics image. It has been found, that when displaying graphic images some objects are clearly in front of others and thus the ones at the back can be thrown away early in the processing whereas others are at similar depths within the field of the displayed image and thus, each must be analysed on a pixel by pixel basis to determine which object is actually in front where. The present embodiment relates to solving this problem by determining on a pixel by pixel basis which parts of several interlocked images are closer to the viewing plane and closer to an observer and should therefore be displayed on a screen.

In the present embodiment, each thread accesses a pixel of a different object, the pixel having a colour component and a depth component. The depth component of that pixel is compared to a depth value that is stored in depth buffer 20. This depth buffer holds the value of the previously analysed object that is closest to the viewing plane of the graphic image at present. Following this comparison, if it is found that the accessed pixel is closer to the viewing plane than the stored depth buffer value then the corresponding colour buffer pixel needs to be updated.

As can be seen from this embodiment, multiple threads are operating in parallel with each other. Thus, there is always a possibility that they may access the same pixel for different objects at the same time and in this case there could occur race conditions in which the same depth buffer value is accessed at approximately the same moment by two threads. In order to avoid this, but to allow the parallel processing to continue the threads access the depth buffer value in a particular way that prevents two processes accessing the same value simultaneously.

In this embodiment, a thread, for example thread 1 accesses a depth buffer value by performing a swap operation in which a lock value is swapped into the depth buffer at a position corresponding to the position of the pixel being analysed. The accessed depth buffer value is compared with a lock value. If the comparison indicates the accessed value is itself a lock value then thread 1 knows that another of the threads is presently accessing this position and it continues to check this position and will attempt to swap in a lock value when it believes the position is no longer locked.

If the value is not a lock value then it is compared with a depth component of the pixel value and if it is found that the pixel depth is closer to the front or viewing plane of the image than the value in the depth buffer value, (in this embodiment if the pixel depth is less than the buffer depth though different embodiments could clearly use different semantics) then it is determined that the colour component of the pixel needs to be entered into colour buffer 30 for this position. This is therefore performed. When it has been performed the depth component relating to the pixel is written into the corresponding position of the depth buffer 20. By doing this the lock is overwritten and the position is therefore automatically unlocked and can be used by other threads.

If it is found that the pixel depth component indicates the pixel to be located further back from the screen than the depth buffer value indicates, i.e. in this embodiment it is greater than the buffer value, then the accessed depth buffer value is swapped back into its position and in that way the position is unlocked and the pixel values that have been accessed are discarded.

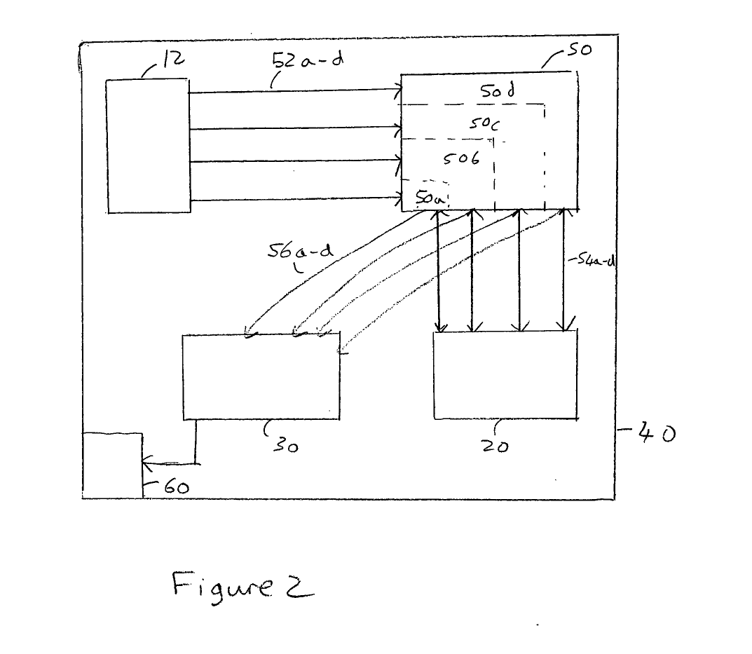

FIG. 2 shows an apparatus according to an embodiment of the present invention. Data processing apparatus 40 comprises a data store 12 storing an object list. A data processor 50, depth buffer 20, colour buffer 30 and a display 60 in which the image is displayed. Data processor 50 is a multiprocessor system comprising a plurality of processors 50a to 50d which are operable to function in parallel to each other. Each of the plurality of processors access an object within object list 12 and compare depth values of the components with depth values stored in depth buffer 20. The apparatus functions in the same way as is described with respect to the functional diagram of FIG. 1.

It should be noted that the process used in the embodiment of FIG. 1 for accessing the depth buffer value and locking the depth buffer position was a swap operation in which the stored value is swapped out and the lock value loaded in. This means that it is an atomic operation that cannot be interrupted. Thus, the depth buffer value is accessed and the lock value placed in that position in the depth buffer in an atomic operation that cannot be interrupted.

An alternative way of accessing the depth buffer would be to use an exclusive load and store operation (LDREX plus STREX). This is in effect two operations but while they are being performed a bit is set on the exclusive monitor if the operation was interrupted. This effectively makes it an atomic operation and as in the swap operation it allows the lock to be set safely in the depth buffer and stops other parallel processes from interfering with the process and accidentally accessing or overwriting the data and thereby causing errors.

The coding of swap and the load and store is set out below.

SWAP
.label1
SWAP lock_value
COMPARE lock_value
JUMP to label2 if lock already held
<lock is now acquired>
.label2
LOAD lock-value
COMPARE lock-value
JUMP back to label2 if still locked
JUMP back to label1 if free
STREX + LDREX
.label
LDREX lock_value
COMPARE lock_value
JUMP back to label if lock already held
STREX lock_value, exclusive_result
COMPARE exclusive_result
JUMP back to label if exclusive_result check fails

As can be seen the LDREX is followed by a comparison, if the comparison finds that the lock has been taken then the thread needs to try again.

In both of the above cases the lock_value is accessed atomically. The STREX+LDREX solution adds complexity to the code but avoids locking the buses.

It should be clear that other mechanisms could be used. Advantageously they should be atomic operations as this ensures the safe running of the program.

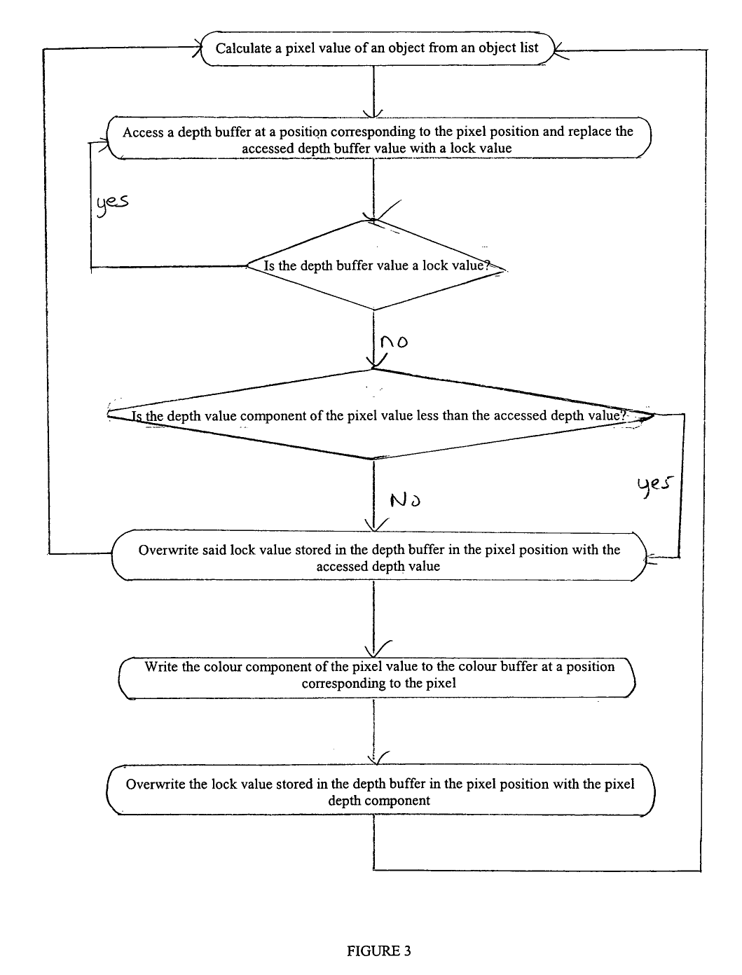

FIG. 3 shows a flow diagram giving the steps of the method performed by an embodiment of the present invention. The steps of the method described here are the steps performed by a single processor. In embodiments of the present invention, a number of parallel processors will be performing these steps in parallel with each other.

In the first step, an object list is accessed and a pixel value of a point on the object is calculated from an object list. A depth buffer is then accessed at a position corresponding to the pixel position and this value is replaced with a lock value. This operation should be performed as an atomic operation using for example a swap. The depth buffer value is then analysed and if it is a lock value this indicates to the processor that another processor is at present accessing this pixel and thus this processor will in effect spin. What it does is continually access this position until it no longer retrieves a lock value. At this point it can continue running. It should be noted that it is unlikely that two processes will be accessing the same pixel position at any one time. Thus, these spin conditions are rare and the parallel nature of the processing can generally be performed in an efficient and uninterrupted way.

Once a value that is not a lock value has been obtained, this depth value is compared with the depth value component of the pixel value. If it is a value that shows that the pixel is nearer the viewing plane of the image than the value currently stored in the depth value then the colour component of the pixel value is written to the colour buffer at a position corresponding to the pixel and following this the depth buffer is updated. This is done by overwriting the lock value that has previously been stored in that position with the new pixel depth component. By doing this, not only is the depth buffer updated as is required, but the lock is automatically freed without the need for an additional step.

If the depth value component of the pixel value is greater than the accessed depth value, i.e. it indicates that the object accessed is behind a previously accessed object in the image then the lock value stored in the depth buffer in the pixel position is overwritten with the previously stored depth value i.e. the value that was previously there is put back in and this frees the lock and allows other processes to access this position. At this point the steps of the method can be performed again by this processor but at a different pixel position. Thus, multiple objects can be analysed in parallel and the graphics processing can be performed more quickly.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. A method of forming a 3D graphics image comprising the steps of:
(i) deriving a pixel value comprising a colour component and a depth component of an object from an object list:
(ii) accessing a depth buffer value stored in a depth buffer at a position corresponding to said pixel and replacing said accessed depth buffer value with a lock value and if said accessed depth buffer value is not said lock value performing the following steps:
(iii) comparing said depth component of said pixel value with said accessed depth buffer value; and
(iva) in response to said comparison indicating said pixel value being closer to a viewing plane of said graphics image than said derived depth buffer value writing said pixel value to a corresponding position in a colour buffer for storing pixels to be displayed and subsequently replacing said lock value in said corresponding position in said depth buffer with said pixel depth value; and
(ivb) in response to said comparison indicating said object being further from said viewing plane of said graphics image than said derived depth buffer value replacing said lock value in said corresponding position in said depth buffer with said accessed depth buffer value.

2. A method according to claim 1, wherein said step (ii) further comprises comparing said accessed depth buffer value with said lock value to determine if said accessed depth buffer value is said lock value or not.

3. A method according to claim 1 wherein in said step (ii) in response to said accessed depth buffer value being said lock value repeating said step (ii) until said accessed depth buffer value comprises a value other than said lock value.

4. A method according to claim 2 wherein in step (ii) said comparing of said accessed depth buffer value with said lock value is done prior to replacing said accessed depth buffer value with said lock value, and if said corresponding depth value is said lock value, said depth buffer is accessed again until said accessed depth buffer value is not said lock value

5. A method according to claim 1, wherein said step (ii) is an atomic operation that cannot be interrupted.

6. A method according to claim 5, wherein said step (ii) comprises a swap operation operable to swap a lock value with said depth buffer value.

7. A method according to claim 5, wherein said step (ii) comprises an exclusive load and store operation.

8. A method according to claim 1, wherein said steps of said method are operable to be performed by a plurality of processors in parallel with each other.

9. A computer program product holding a computer readable medium including computer readable instructions that when executed perform the steps of a method according to claim 1.

10. A computer program product which is operable when run on a multiprocessor system to control a plurality of processors to perform the steps of a method according to claim 8 in parallel with each other.

11. A data processing apparatus operable to form a graphics image comprising:
a data store for storing an object list of objects to be displayed within said graphics image;
a colour buffer operable to store a plurality of pixels to be displayed as said graphics image;
a depth buffer operable to store a depth value corresponding to a distance of a pixel within said colour buffer from a front of said graphics image;
a plurality of data processors operable to process data in parallel, each of said plurality of data processors being operable to:
derive a pixel value of an object from said object list;
access a depth buffer value stored in said depth buffer at a position corresponding to said pixel and to replace it with a lock value and in response to said accessed depth buffer value not being said lock value, to:
compare a depth of said pixel value with said accessed depth buffer value; and either
in response to said comparison indicating said pixel value being closer to a viewing plane of said graphics image than said accessed depth buffer value said data processor is operable to write said pixel value to a corresponding position in said colour buffer and subsequently replace said lock value in said corresponding position in said depth buffer with a depth of said pixel value; or
in response to said comparison indicating said object being further from said viewing plane of said graphics image than said accessed depth buffer value said data processor is operable to replace said lock value in said corresponding position in said depth buffer with said accessed depth buffer value.
